(19) United States
(12) Patent Application Publication
(10) Pub. No.: US 2008/0141660 A1
(43) Pub. Date: Jun. 19, 2008

(54) Catalyst And System For Reducing Exhaust Of Diesel Engines

(75) Inventors: Min-Yong Kim, Seoul (KR); Hae-Soo Lee, Gyeonggi-Do (KR); Jae-Hoon Chung, Seoul (KR)

Correspondence Address: IPLA P.A., 3580 WILSHIRE BLVD., 17TH FLOOR, LOS ANGELES, CA, 90010, US

(73) Assignee: END SOLUTIONS INC., Seoul (KR)

(21) Appl. No.: 11/722,515

(22) PCT Filed: Jan. 26, 2006
(86) PCT No.: PCT/KR2006/000312

§ 371 Date: Jun. 21, 2007

(30) Foreign Application Priority Data
Jan. 27, 2005 (KR) 10-2005-0007428

(51) Int. Cl. F01N 3/035; B01J 23/44; B01J 23/42; B01J 23/46; B01J 23/40; B01J 23/58; B01J 23/50; B01J 21/06

(52) U.S. Cl. 60/286; 502/332; 502/333; 502/334; 502/330; 502/348; 502/351; 60/299

(57) ABSTRACT

The present invention relates to a novel catalyst composition for use in a nitrogen oxide removal unit (DeNOx), a diesel particulate filter (DPF) and a diesel oxidation catalyst (DOC) unit, as well as a diesel exhaust after-treatment system comprising the same. In the diesel exhaust after-treatment system, the catalyzed ceramic filter ha s a low balance point temperature, and thus it can be operated even at low temperatures without an increase in back pressure. At a lower temperature, it can be continuously regenerated by the injection of heated light oil without applying excessive load to engines. Also, it can efficiently remove carbon monoxide and hydrocarbon with a high efficiency at low temperatures. In addition, according to the present invention, the number of particulate matters of less than 1 D can be decreased by the DOC catalyst honeycomb structure positioned in the rear of the ceramic filter, and nitrogen oxide can be removed by the DeNOx catalyst honeycomb structure positioned in front of the ceramic filter.

### TECHNICAL FIELD

The present invention relates to a catalyst for reducing exhaust from diesel engines, and a diesel engine exhaust after-treatment system including the same.

### BACKGROUND ART

Worldwide interest in the environment started to increase in the latter half of the 1980s, and particularly, solutions to air pollution started to be discussed worldwide starting with the Framework Convention on Climate Change. Thus, in the automobile field, studies on fuel economy and safety as well as the reduction of exhaust gas have also been recently actively conducted.

Components of exhaust from diesel automobiles, which are currently regulated by the law, are carbon monoxide (CO), hydrocarbons (HC), nitrogen oxides (NOₓ) and particulate matters (PM). Diesel engines have low emissions of carbon monoxide and hydrocarbon because fuel is combusted at a high excess air ratio, whereas they have high emissions of nitrogen oxides and particulate matters. Thus, studies on the reduction of nitrogen oxides and particulate matters have been actively conducted.

Systems for treating exhaust from diesel engines can be broadly divided into diesel particulate filters (hereinafter, also referred to as “DPF”), diesel oxidation catalyst units (hereinafter, also referred to as “DOC”), and nitrogen oxide removal units (hereinafter, also referred to as “DeNOx”).

Diesel particulate filters (DPF) are systems for removing particulate matter (PM) and are known as technologies capable of removing generally more than 80% of particulate matters. Diesel oxidation catalyst units (DOC) are systems for removing hydrocarbon and carbon monoxide and are known to have a removal efficiency of generally more than 70%. Nitrogen oxide removal units (DeNOx) are systems for removing nitrogen oxides from exhaust gas.

The prior patents related to the diesel oxidation catalyst units (DOC) are as follows.

U.S. Pat. No. 4,059,675 discloses a method for decomposing chlorinated organic compounds using a ruthenium (Ru) catalyst in the presence of an oxidizing agent.

U.S. Pat. No. 4,059,676 discloses a method for decomposing halogenated organic compounds using a ruthenium-platinum catalyst in the presence of an oxidizing agent, and U.S. Pat. No. 4,059,683 discloses a method for decomposing halogenated organic compounds using a platinum catalyst in the presence of an oxidizing agent.

U.S. Pat. No. 4,983,366 discloses a method for removing hydrocarbon, halogenated hydrocarbon and carbon monoxide, comprising treating waste gases with a two-stage catalyst system consisting of a catalyst for oxidative cracking and a catalyst for oxidative afterburning, wherein the catalyst for oxidative cracking contains an oxide of barium (Ba), magnesium (Mg) or copper (Cu) on a supporter material, such as aluminum oxide (Al₂O₃), silicone (SiO₂), aluminum silicate, zeolite or the like, and the catalyst for oxidative afterburning contains platinum, palladium, platinum/palladium, or platinum/rhodium, on said supporter material.

To oxidize organic compounds including halogenated organic compounds, PCT/US90/2386 discloses a catalyst containing V₂O₅, SnO₂ and precious metal on a titania supporter.

U.S. Pat. No. 5,283,041 discloses a catalyst for treating organic compounds including halogenated organic compounds, the catalyst comprising vanadium oxide, ZrO₂ and at least one oxide selected from manganese oxide, cerium oxide and cobalt oxide.

However, the prior catalysts disclosed in said patents have a problem in that they decompose volatile organic compounds and carbon monoxide at a space velocity of 30,000 h¹-50,000 h¹, indicating a too-low treatment rate per unit of time.

The nitrogen oxide removal units (DeNOx) use various methods, including catalytic decomposition, selective catalytic reduction, selective noncatalytic reduction, non-selective catalytic reduction, and adsorption. Among these methods, selective catalytic reduction and nonselective catalytic reduction are frequently used and will now be described.

The selective catalytic reduction is the technology of reducing nitrogen oxide into nitrogen using ammonia (NH₃) or urea [CO(NH₂)₂] as a reducing agent. Catalysts widely used in this technology comprise V₂0₅, MoO₃, Fe₂O₃SnO₂, Mn₂O₃, CuSO₄, WO₃, and/or VOSO₄ supported on a supporter material, such as TiO₂ or SiO₂. Patents related to the selective catalytic reduction include U.S. Pat. Nos. 3,216,953, 3,407,215, 4,010,238, 4,048,112, 4,085,193, 4,113,660, 4,113,660, 4,176,089, 4,188,365, 4,221,768, 4,225,462, 4,280,926, 4,489,172, 4,520,124, 4,705,770, 4,725,572, 4,742,037, 4,774,219, 4,833,113, 4,929,586, etc. The method of using urea or ammonia has an advantage in that it has a high conversion efficiency of more than 90%. However, the method has problems in that it requires a large amount of catalysts corresponding to a space velocity of about 3,000 h¹-10,000 h¹, and needs to use an additional system for supplying urea or ammonia, leading to an increase in cost. Another problem is that, when a portion of ammonia is discharged as exhaust, it can cause environmental problems.

The nonselective catalytic reduction is the technology of reducing nitrogen oxide into nitrogen using hydrogen, methane, carbon monoxide, hydrocarbon or the like as a reducing agent. Catalysts used in this technology comprise copper or cobalt supported on zeolite, or a precious metal supported on alumina. However, these catalysts are disadvantageous in that they have a lower conversion rate than the selective catalytic reduction, and low resistance to water, and become weak in low-temperature reduction reactions.

The diesel particulate filter (DPF) systems are technologies for removing particulate matter (PM) by capturing particulate matter discharged from diesel engines by a filter, burning the captured matter into ash, and repeating the capturing and burning steps. These systems can reduce more than 80% of particulate matters, indicating very excellent performance, but have low durability and economical efficiency, which interfere with the practical use of the systems. Also, as particulate matter is captured by the filter, back pressure is applied to engines, thus somewhat reducing the output and fuel consumption rate of the engines. Thus, technical improvements for minimizing this phenomenon are needed.

Meanwhile, in the prior art, there is also technology in which the diesel oxidation catalyst unit (DOC) is positioned in front of the diesel particulate filter, and a catalyzed ceramic filter is positioned in the rear of the diesel particulate filter, so that the balance point temperature (BPT) of the filter can be lowered. However, this technology has a problem in that, even if the diesel oxidation catalyst is positioned in front of the diesel particulate filter, the balance point temperature of the filter will still be high, and so the back pressure at low velocity and low temperature will increase, thus applying excessive loads to engines.

### DISCLOSURE OF INVENTION

### Technical Problem

It is an object to provide a novel catalyst composition and system capable of removing diesel exhaust gas in a more efficient manner than the above-described prior catalyst composition and system for treating diesel exhaust gas.

### Technical Solution

To achieve the above object, the present invention provides a catalyst composition for the oxidation of carbon monoxide (CO), hydrocarbon (HC) and particulate matter, the catalyst composition comprising: (I) an inorganic refractory supporter consisting of a mixture of Al₂O₄ and BaTiO₃; and (II) a catalyst comprising: (i) at least one platinum-group metal selected from the group consisting of rubidium (Rb), ruthenium (Ru), rhodium (Rh), palladium (Pd), osmium (Os), iridium (Ir) and platinum (Pt); and (ii) at least one fifth-period metal selected from the group consisting of rubidium (Rb), strontium (Sr) and yttrium (Y).

Preferably, in the catalyst composition, the platinum-group metal is contained in an amount of 0.1-100 parts by weight based on 1 part by weight of the fifth-period metal.

Preferably, the inorganic refractory supporter is contained in an amount of 10-1,000 parts by weight based on 1 part by weight of the catalyst components (i) and (ii).

Preferably, the BaTiO₃ component in the supporter is contained in an amount of 0.01-100 parts by weight based on 1 part by weight of the Al₂O₃ component.

In another aspect, the present invention provides a diesel particulate filter containing said catalyst composition for the oxidation of carbon monoxide (CO), hydrocarbon (HC) and particulate matter (PM).

In still another aspect, the present invention provides a diesel oxidation catalyst unit (DOC) comprising said catalyst for the oxidation of carbon monoxide (CO), hydrocarbon (HC) and particulate matter (PM).

In still another aspect, the present invention provides a diesel exhaust after-treatment system comprising both the diesel particulate filter (DPF) and the diesel oxidation catalyst unit (DOC).

In still another aspect, the present invention provides a catalyst composition for the reduction of nitrogen oxide, comprising: (I) an inorganic refractory supporter consisting of Al₂O₃ and BaTiO₃; and (II) a catalyst comprising: (i) at least one fifth-period metal selected from the group consisting of rubidium (Ru), palladium (Pd), silver (Ag), zirconium (Zr), niobium (Nb) and indium (In); and (ii) at least one group I metal selected from the group consisting of lithium (Li), rubidium (Rb), cesium (Cs) and francium (Fr).

In the catalyst for the reduction of nitrogen oxide, the fifth-period metal is preferably contained in an amount of 0.1-100 parts by weight based on 1 part by weight of the group I metal.

Preferably, the inorganic refractory supporter is contained in an amount of 10-1,000 parts by weight based on 1 part by weight of the catalyst components (i) and (ii).

Preferably, the BaTiO₃ component in the supporter is contained in an amount of 0.01-100 parts by weight based on 1 part by weight of the Al₂O₃ component.

In still another aspect, the present invention provides a nitrogen oxide removal unit (DeNOx) comprising said catalyst composition for the reduction of nitrogen oxide.

In a preferred embodiment of the diesel exhaust after-treatment system according to the present invention, a pressure sensor, a light oil (or dimethyl ether) injection nozzle and a heater for the injection nozzle are positioned in front of the nitrogen oxide removal unit (DeNOx), such that a predetermined amount of light oil (or dimethyl ether) is injected, if necessary, to remove nitrogen oxide (NOx), depending on nitrogen oxide emission calculated based on the RPM and load of an engine. Also, in the diesel exhaust after-treatment system, a pressure sensor is positioned in the rear of the diesel particulate filter (DPF), such that, if the pressure difference between the pressure sensor of the nitrogen oxide removal unit and the pressure sensor of the diesel particulate filter (DPF) is more than 200 mbar, the amount of light oil (or dimethyl ether) injected through the injection nozzle will be increased compared to the amount required as a reducing agent in the nitrogen oxide removal unit and oxidized in the ceramic filter of the diesel particulate filter to generate instantaneous heat so as to regenerate deposited particulate matter at low temperatures, and if the pressure difference is less than 150 mbar, light oil (or dimethyl ether) will be injected through the nozzle in the amount required in the nitrogen oxide removal unit (DeNOx).

Preferably, the diesel exhaust after-treatment system according to the present invention additionally comprises a diesel oxidation catalyst unit (DOC).

In another preferred embodiment of the diesel exhaust after-treatment system according to the present invention, a pressure sensor, a light oil (or dimethyl ether) injection nozzle and a heater for the injection nozzle are positioned in front of the nitrogen oxide removal unit (DeNOx), such that a predetermined amount of light oil (or dimethyl ether) is injected, if necessary, to remove nitrogen oxide (NOx), depending on nitrogen oxide emission calculated based on the RPM and load of an engine. Also, in the diesel exhaust after-treatment system, a pressure sensor is positioned in the rear of the diesel particulate filter (DPF), such that, if the pressure difference between the pressure sensor of the nitrogen oxide removal unit and the pressure sensor of the diesel particulate filter (DPF) is more than 200 mbar, the amount of injection of light oil (or dimethyl ether) through the injection nozzle will be increased compared to the amount required as a reducing agent in the nitrogen oxide removal unit and oxidized in the ceramic filter of the diesel particulate filter to generate instantaneous heat so as to regenerate deposited particulate material at low temperatures, and if the pressure difference is less than 150 mbar, light oil (or dimethyl ether) will be injected through the nozzle in the amount required in the nitrogen oxide removal unit (DeNOx). Also, the diesel oxidation catalyst unit (DOC) provided in the diesel exhaust after-treatment system serves to remove particulate matter of less than 1 □, hydrocarbon and carbon monoxide, untreated in the diesel particulate filter (DPF).

### Advantageous Effects

In the diesel exhaust after-treatment system, the catalyzed ceramic filter has a low balance point temperature, and thus, it can be operated even at low temperatures without an increase in back pressure. At a lower temperature, it can be continuously regenerated by the injection of heated light oil without applying excessive load to engines. Also, it can effectively remove carbon monoxide and hydrocarbon in a high efficiency at low temperatures. In addition, according to the present invention, the amount of particulate matter of less than 1 □ can be decreased by the DOC catalyst honeycomb structure positioned in the rear of the ceramic filter, and nitrogen oxide can be removed by the DeNOx catalyst honeycomb structure positioned in front of the ceramic filter.

### BRIEF DESCRIPTION OF THE DRAWINGS

FIG. 1 shows a diesel exhaust after-treatment system comprising a nitrogen oxide removal unit (DeNOx), a diesel particulate system (DPF) and a diesel oxide catalyst system (DOC).

FIG. 2 shows a diesel exhaust after-treatment system comprising a nitrogen oxide removal unit (DeNOx) and a diesel particulate filter (DPF).

FIG. 3 shows a diesel exhaust after-treatment system comprising a diesel particulate filter (DPF) and a diesel oxidation catalyst unit (DOC).

### BEST MODE FOR CARRYING OUT THE INVENTION

Hereinafter, the present invention will be described in more detail.

The present invention provides novel catalyst compositions for use in a nitrogen oxide removal unit (DeNOx), a diesel particulate filter (DPF) and a diesel oxidation catalyst unit (DOC). As used herein, the phrase “catalyst compositions for use in a nitrogen oxide removal unit (DeNOx), a diesel particulate filter (DPF) and a diesel oxidation catalyst unit (DOC)” have interchangeable meanings and are fundamentally the same in preparation methods and application methods except that they are applied to either a ceramic filter of the diesel particulate filter or a honeycomb-like structure of the diesel oxidation catalyst unit.

The inventive catalyst composition for use in the diesel particulate filter and the diesel oxidation catalyst unit comprises: (I) an inorganic refractory supporter consisting of a mixture of Al₂O₃ and BaTiO ; and (II) a catalyst comprising: (A) at least one platinum-group metal selected from the group consisting of rubidium (Rb), ruthenium (Ru), rhodium (Rh), palladium (Pd), osmium (Os), iridium (Ir) and platinum (Pt); and (B) at least one fifth-period metal selected from the group consisting of rubidium (Rb), strontium (Sr) and yttrium (Y).

The weight ratios between the components used in the inventive catalyst are preferably as follows.

(i) the component (A) is used in an amount of 0.1-100 parts by weight based on 1 part by weight of the component (B);

(ii) the inorganic refractory supporter is used in an amount of 10-1,000 parts by weight based on 1 part by weight of the components (A) and (B);

(iii) if the component (A) or (B) consists of more than two metals, the weight ratio between the metals of each of the components (A) and (B) will be in the range of the weight ratio of the components (A) and (B) to the mixture of Al₂O₃ and BaTiO₃; and

(iv) the BaTiO₃ component of the supporter is used in an amount of 0.01-100 parts by weight based on 1 part by weight of the BaTiO component.

The catalyst composition can be applied to a ceramic filter for diesel particulate filters or a honeycomb-like structure for diesel oxidation catalyst units in the following manner. An inorganic refractory slurry comprising a mixture of Al₂O₃ and BaTiO₃ is wash-coated on a ceramic filter for the diesel particulate filter or on a honeycomb-like structure for the diesel oxidation catalyst unit and then dried at a temperature of more than 110° C. for at least 12 hours. The resulting ceramic filter or honeycomb structure is impregnated with a composition comprising at least one platinum-group metal selected from the group consisting of rubidium (Rb), ruthenium (Ru), rhodium (Rh), palladium (Pd), osmium (Os), iridium (Ir) and platinum (Pt) and at least one fifth-period metal selected from the group consisting of rubidium (Rb), strontium (Sr) and yttrium (Y) and then dried at a temperature of more than 110° C. for at least 12 hours. Next, the dried ceramic filter or honeycomb structure is calcined at a temperature of 300-600° C. for at least 4 hours, thus manufacturing a diesel particulate filter (DPF) or diesel oxidation catalyst unit (DOC) comprising the catalyst for the oxidation of carbon monoxide (CO), hydrocarbon (HC) and particulate matter (PM).

The inventive catalyst for use in the nitrogen oxide removal unit (DeNOx) comprises: (i) an inorganic refractory supporter consisting of Al₂O₃ and BaTiO₃; and (ii) a catalyst comprising: (C) at least one fifth-period metal selected from the group consisting of rubidium (Ru), palladium (Pd), silver (Ag), zirconium (Zr), niobium (Nb) and indium (In); and (D) at least one group I metal selected from the group consisting of lithium (Li), rubidium (Rb), cesium (Cs) and francium (Fr).

The weight ratios between the components used in the inventive catalyst are preferably as follows.

(i) the component (D) is used in an amount of 0.1-100 parts by weight based on 1 part by weight of the component (C);

(ii) the inorganic refractory supporter is used in an amount of 10-1,000 parts by weight based on 1 part by weight of the components (C) and (D);

(iii) if the component (C) or (D) consists of more than two metals, the weight ratio between the metals of each of the components (C) and (D) will be in the range of the weight ratio of the components (C) and (D) to the mixture of Al₂O₃ and BaTiO₃; and

(iv) the BaTiO₃ component of the supporter is used in an amount of 0.01-100 parts by weight based on 1 part by weight of the BaTiO₃ component.

The catalyst composition can be applied to the nitrogen oxide removal unit (DeNOx) in the following manner.

An inorganic refractory slurry comprising a mixture of Al₂O₃ and BaTiO₃ is wash-coated on a honeycomb-like structure for nitrogen oxide removal units (DeNOx) and then dried at a temperature of more than 110° C. for at least 12 hours. The resulting honeycomb structure is impregnated with a composition comprising at least one fifth-period metal selected from the group consisting of rubidium (Ru), palladium (Pd), silver (Ag), zirconium (Zr), niobium (Nb) and indium (In); and at least one group I metal selected from the group consisting of lithium (Li), rubidium (Rb), cesium (Cs) and francium (Fr) and then dried at a temperature of more than 110° C. for at least 12 hours. Next, the dried honeycomb structure is calcined at a temperature of 300-600° C. for at least 4 hours, thus manufacturing a nitrogen oxide removal unit (DeNOx).

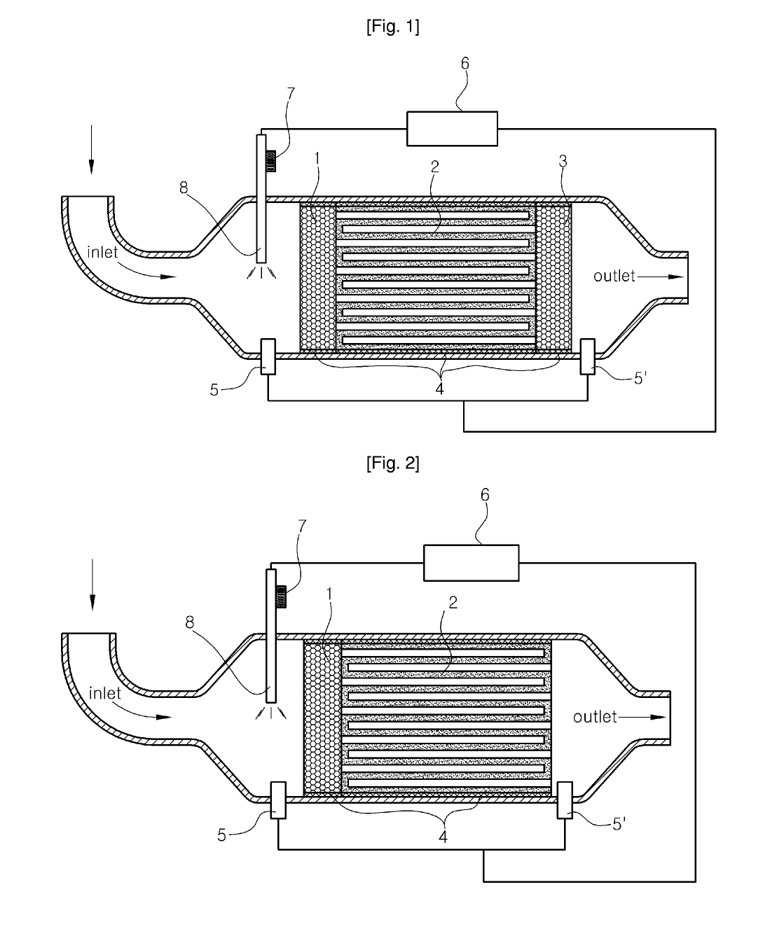

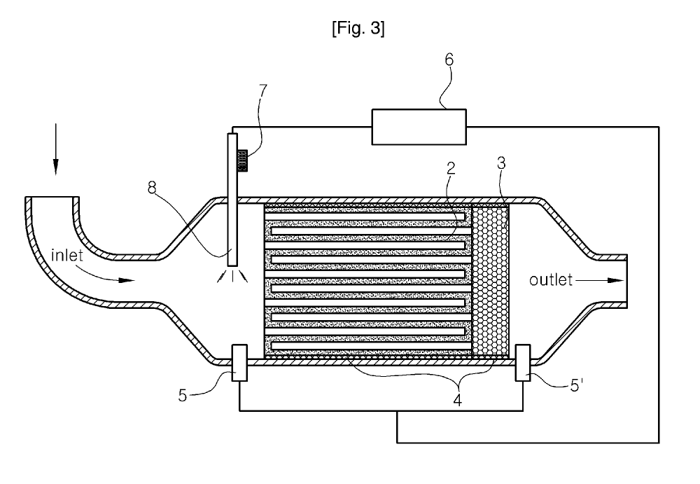

As shown in FIG. 1, the nitrogen oxide removal unit (DeNOx), together with the diesel particulate filter (DPF) and the diesel oxidation catalyst unit (DOC), can constitute the diesel exhaust after-treatment system. In this regard, the arrangement is preferably made in the order of the nitrogen oxide removal unit (DeNOx), the diesel particulate filter (DPF) and the diesel oxidation catalyst unit (DOC), starting at an exhaust manifold. However, as shown in FIG. 2, the diesel exhaust after-treatment system may, if necessary, consist of only the nitrogen oxide removal unit (DeNOx) and the diesel particulate filter (DPF). Alternatively, as shown in FIG. 3, the diesel exhaust after-treatment system may also consist of only the diesel particulate filter (DPF) and the diesel oxidation catalyst unit (DOC).

As shown in FIG. 1, a pressure sensor 5, a light oil (or DME) injection nozzle 8 and a heater 7 are positioned in front of a catalyzed honeycomb structure 1. Thus, depending on nitrogen oxide emission calculated based on the RPM and load of an engine, a predetermined amount of heated light oil (or DME) is injected to remove nitrogen oxide from the honeycomb structure 1 of the nitrogen oxide removal unit. And, if the pressure difference between the pressure sensor 5 positioned in front of the DeNOx and the pressure sensor 5′ in the rear of the DOC is more than 200 mbar, the amount of light oil (or DME) heated in the heater 7 and injected from the injection nozzle 8 will be increased compared to the amount required as a reducing agent in the DeNOx catalyst honeycomb 1, and a portion of the injected light oil (or DME) is oxidized in the ceramic filter 2 of the diesel particulate filter to generate instantaneous heat so as to combust (regenerate) deposited particulate matter, such that particulate matter can be continuously captured by the ceramic filter 2 of the DPF without being deposited in the ceramic filter 2. On the other hand, if the pressure difference between the pressure sensor is less than 150 mbar, the amount of light oil (or DME) injected through the nozzle 8 will be controlled by a control panel 6 such that it is injected in the amount required in the DeNOx catalyst honeycomb structure 1. When the engine exhaust is passed through only the DeNOx and the DPF as described above, there will be a problem in that the total number of particulate matters increases although the total amount of particulate matters decreases. To overcome this problem, as shown in FIG. 1, the diesel oxidation catalyst unit may also be additionally positioned in the rear of the diesel particulate filter, such that fine particles of less than 1 □, untreated in the catalyzed ceramic filter 2, can be additionally removed in the catalyst honeycomb structure 3 of the diesel oxidation catalyst unit, whereby the amount and number of particulate matters can be decreased.

FIG. 2 shows a diesel exhaust after-treatment system which has the same construction as that in FIG. 1, except that the diesel oxidation catalyst unit (DOC) is not included. Thus, because the fundamental principle of the system shown in FIG. 2 is the same as the system in FIG. 1, the operation principle thereof will be omitted herein.

FIG. 3 shows a diesel exhaust after-treatment system which has the same construction as that in FIG. 1, except that the nitrogen oxide removal unit (DeNOx) is not included. The fundamental operation principle of the exhaust after-treatment system shown in FIG. 3 is the same as that in FIG. 1. Namely, if the pressure difference between the pressure sensor 5 in front of the diesel particulate filter (DPF) and the pressure sensor 5′ in the rear of the diesel oxidation catalyst unit (DOC) is more than 200 mbar, heated light oil (or DME) will be injected to combust deposited particulate matter (PM), and if the pressure difference is less than 150 mbar, the injection of the heated light oil will be stopped such that particulate matter, carbon monoxide and hydrocarbon can be removed only by the catalyst at the temperature of exhaust gas.

### Mode for the Invention

Hereinafter, the present invention will be described in detail by examples.

### EXAMPLE 1

### DPF

500 g of gamma-alumina and 500 g of BaTiO₂ were wet pulverized with a ball mill for 20 hours to prepare an aqueous slurry. Then, a ceramic filter, which was 11.25 inches in inner diameter and 14 inches in length and had about 200 pore cells per square inch, was immersed in the slurry and drawn out from the slurry, and an excess of slurry in the cells was blown off with compressed air. The resulting ceramic filter was dried at 120° C. for 12 hours. The dried ceramic filter was impregnated by immersion in an aqueous chloroplatinic acid solution containing 20 g of Pt as the platinum-group metal component (A) and 5 g of Rb as the fifth-period metal component (B), and then dried at 120° C. for 12 hours. The dried ceramic filter was calcined at 400° C. for 2 hours, thus manufacturing a catalyzed ceramic filter for DPF.

### EXAMPLE 2

### DPF

The process of Example 1 was repeated except that the component (A) was 15 g of Pt and the component (B) was 5 g of Sr.

### EXAMPLE 3

### DPF

The process of Example 1 was repeated except that the component (A) was 15 g of Pd and the component (B) was 5 g of Y.

### EXAMPLE 4

### DPF+DOC

In Example 4, a diesel exhaust after-treatment system comprising DPF positioned in the front thereof and DOC positioned in the rear thereof was manufactured in the following manner. 250 g of gamma-alumina and 250 g of BaTiO₂ were wet pulverized with a ball mill for 20 hours to prepare an aqueous slurry. Then, a ceramic filter, which was 11.25 inches in inner diameter and 3 inches in length and had about 200 pore cells per square inch, was immersed in the slurry and drawn out from the slurry, and an excess of slurry in the cells was blown off with compressed air. The resulting ceramic filter was dried at 120° C. for 12 hours. The dried ceramic filter was impregnated by immersion in an aqueous chloroplatinic acid solution containing 20 g of Pt as the platinum-group metal component (A) and 5 g of Rb as the fifth-period metal component (B), and then dried at 120° C. for 12 hours. The dried ceramic filter was calcined at 400° C. for 2 hours, thus manufacturing a catalyzed ceramic filter for DOC. Also, a ceramic filter for DPF was manufactured in the same manner as in Example 1.

### EXAMPLE 5

### DPF+DOC

DOC was manufactured in the same manner as in Example 1, except that the component (A) was a mixture of 15 g Rb and 5 g Pd, and the component (B) was a mixture of 3 g Rb and 2 g Y. Also, DPF was manufactured in the same manner as in Example 1, except that the component (A) was a mixture of 15 g Rb and 5 g Pd, and the component (B) was a mixture of 3 g Rb and 2 g Y.

### EXAMPLE 6

### DPF+DeNOx

In Example 6, a diesel exhaust after-treatment system comprising DeNOx positioned in the front thereof and DPF positioned in the rear thereof was manufactured in the following manner. 500 g of gamma-alumina and 5,000 g of BaTiO₂ were wet pulverized with a ball mill for 20 hours to prepare an aqueous slurry. Then, a ceramic filter, which was 11.25 inches in inner diameter and 6 inches in length and had about 200 pore cells per square inch, was immersed in the slurry and drawn out from the slurry, and an excess of slurry in the cells was blown off with compressed air. The resulting ceramic filter was dried at 120° C. for 12 hours. The dried ceramic filter was impregnated by immersion in a mixed aqueous solution containing a mixture of 5 g Pd and 5 g In as the fifth-period metal component (C) and a mixture of 3 g Li and 2 g Fr as the group I metal component, and then dried at 120° C. for 12 hours. The dried ceramic filter was calcined at 400° C. for 2 hours, thus manufacturing a catalyzed ceramic filter for DeNOx. Also, DPF was manufactured in the same manner as in Example 1, except that the component (A) was a mixture of 15 g Rb and 5 g Pd, and the component (B) was a mixture of 3 g Rb and 2 g Y.

### EXAMPLE 7

### DeNOx +DPF

A catalyzed ceramic honeycomb structure for DeNox was manufactured in the same manner as in Example 6, except that the component (C) was a mixture of 5 g Ru and 5 g Nb, and the component (D) was a mixture of 3 g Cs and 2 g Rb. Also, DPF was manufactured in the same manner as in Example 1, except that the component (A) was a mixture of 15 g Rb and 5 g Pd, and the component (B) was a mixture of 3 g Rb and 2 g Y.

### EXAMPLE 8

### DeNOx+DPF+DOC

DPF was manufactured in the same manner as in Example 1, except that the component (A) was a mixture of 15 g Rb and 5 g Pd, and the component (B) was a mixture of 3 g Rb and 2 g Y. Also, DOC was manufactured in the same manner as in Example 4, except that the component (A) was a mixture of 15 g Rb and 5 g Pd, and the component (B) was a mixture of 3 g Rb and 2 g Y. Also, DeNOx was manufactured in the same manner as in Example 6, except that the component (C) was a mixture of 5 g Pd and 5 g In 5 g, and the component (D) was a mixture of 3 g Li and 2 g Rb.

### COMPARATIVE EXAMPLE 1

### DPF

DPF was manufactured in the same manner as in Example 1, except that 1000 g of gamma-alumina was used alone as the refractory supporter, the component was 25 g Pt, and the component (B) was not used.

### COMPARATIVE EXAMPLE 2

### DPF

DPF was manufactured in the same manner as in Comparative Example 1, except that the component (A) was not used and the component (B) was 25 g rubidium (Rb).

### COMPARATIVE EXAMPLE 3

### DeNOx+DPF

DeNOx was manufactured in the same manner as in Example 6, except that the component (C) was not used and the component (D) 15 g rubidium (Rb). DPF was manufactured in the same manner as in Example 5.

### COMPARATIVE EXAMPLE 4

### DeNOx+DPF

DeNOx was manufactured in the same manner as in Example 6, except that the component (D) was not used and the component (C) was 15 g Ag. DPF was manufactured in the same manner as in Example 5.

TABLE 1
Components of Examples and Comparative Examples

| | DPF | | DOC | | DeNOx | |
|---|---|---|---|---|---|---|
| | Component A | Component B | Component A | Component B | Component C | Component D |
| Example 1 | 20 g Pt | 5 g Rb | — | — | — | — |
| Example 2 | 15 g Pt5 g | 5 g Sr | — | — | — | — |
| | Pd | | | | | |
| Example 3 | 15 g Pd5 g | 5 g Y | — | — | — | — |
| | Ru | | | | | |
| Example 4 | 20 g Pt | 5 g Rb | 20 g Pt | 5 g Rb | — | — |
| Example 5 | 15 g Rb5 g | 3 g Rb2 g Y | 15 g Rb5 g | 3 g Rb2 g Y | — | — |
| | Pd | | Pd | | | |
| Example 6 | 15 g Rb5 g | 3 g Rb2 g Y | — | — | 5 g Pd5 g In | 3 g Li2 g Fr |
| | Pd | | | | | |
| Example 7 | 15 g Rb5 g | 3 g Rb2 g Y | — | — | 5 g Ru5 g | 3 g Cs2 g |
| | Pd | | | | Nb | Rb |
| Example 8 | 15 g Rb5 g | 3 g Rb2 g Y | 15 g Rb5 g | 3 g Rb2 g Y | 5 g Pd5 g In | 3 g Li2 g |
| | Pd | | Pd | | | Rb |
| Comp. | 25 g Pt | — | — | — | — | — |
| Example 1 | | | | | | |
| Comp. | — | 25 g Rb | — | — | — | — |
| Example 2 | | | | | | |
| Comp. | 15 g Rb5 g | 3 g Rb2 g Y | — | — | — | 15 g Rb |
| Example 3 | Pd | | | | | |
| Comp. | 15 g Rb5 g | 3 g Rb2 g Y | — | — | 15 g Ag | — |
| Example 4 | Pd | | | | | |

Test Example

The catalyst systems manufactured in Examples 1-8 and Comparative Examples 1-4 were tested for the percent removal of diesel exhaust gases, including CO, NOx, PM and THC. The test was performed using an engine dynamometer. The engine used was Model D6AB(Q-dd) (manufactured by Hyundai Motor Company; 6-cylinder, 4-stroke, turbocharger intercooler). In the engine, fuel was directly injected, compression ratio was 17.2:1, and displacement volume was 11,149 cc. The catalyst systems were tested for durability for 200 hours according to the Seoul-10 mode and then evaluated for performance according to the ND-13 mode. Also, balance point temperatures (BPT) were measured. The results are shown in Table 2.

TABLE 2
Test results for reduction of exhaust gas

| | | | Total | | | |
|---|---|---|---|---|---|---|
| | | Carbon | hydro- | | | |
| | | monoxide | carbon | NOx | PM | Removal |
| | BTC | removal | removal | removal | removal | (%) of PM |
| | (° C.) | (%) | (%) | (%) | (%) | number |
| Example 1 | 280 | 87 | 81 | 0 | 93 | −5 |
| Example 2 | 275 | 89 | 84 | 0 | 94 | −5 |
| Example 3 | 280 | 86 | 80 | 0 | 92 | −6 |
| Example 4 | 275 | 96 | 93 | 0 | 97 | 62 |
| Example 5 | 275 | 95 | 94 | 0 | 98 | 66 |
| Example 6 | 275 | 89 | 85 | 75 | 94 | −5 |
| Example 7 | 275 | 89 | 85 | 76 | 94 | −5 |
| Example 8 | 275 | 95 | 94 | 75 | 98 | 66 |
| Comparative | 340 | 76 | 64 | 0 | 90 | −5 |
| Example 1 | | | | | | |
| Comparative | 365 | 36 | 31 | 0 | 87 | −5 |
| Example 2 | | | | | | |
| Comparative | 365 | 85 | 79 | 5 | 94 | −5 |
| Example 3 | | | | | | |
| Comparative | 365 | 84 | 80 | 4 | 94 | −5 |
| Example 4 | | | | | | |

### INDUSTRIAL APPLICABILITY

As described above in detail, the catalyzed ceramic filter used in the present invention has a low balance point temperature, and thus it can be operated even at low temperatures without an increase in back pressure. At a lower temperature, it can be continuously regenerated by the injection of heated light oil without applying excessive load to engines. Also, it can effectively remove carbon monoxide and hydrocarbon in a high efficiency at low temperatures. In addition, according to the present invention, the number of particulate matters of less than 1 □ can be decreased by the DOC catalyst honeycomb structure positioned in the rear of the ceramic filter, and nitrogen oxide can be removed by the DeNOx catalyst honeycomb structure positioned in front of the ceramic filter.

1. A catalyst composition for the oxidation of carbon monoxide (CO) hydrocarbon (HC) and particulate matter, the catalyst composition comprising:
(I) an inorganic refractory supporter consisting of a mixture of Al₂O₃ and BaTiO₃; and
(II) a catalyst comprising:
(i) at least one platinum-group metal selected from the group consisting of rubidium (Rb), ruthenium (Ru), rhodium (Rh), palladium (Pd), osmium (Os), iridium (Ir) and platinum (Pt), wherein the platinum-group metal is contained in an amount of 0.1-100 parts by weight based on 1 part by weight of the fifth-period metal; and
(ii) at least one fifth-period metal selected from the group consisting of rubidium (Rb). strontium (Sr) and yttrium (Y).

2. (canceled)

3. The catalyst composition of claim 1, wherein the inorganic refractory supporter is contained in an amount of 10-1,000 parts by weight based on 1 part by weight of the catalyst components (i) and (ii).

4. A catalyst composition for the reduction of nitrogen oxide, comprising:
(I) an inorganic refractory supporter consisting of a mixture of Al₂O₃ and BaTiO₃; and
(II) a catalyst comprising:
(i) 1 part of weight of at least one group I metal selected from the group consisting of lithium (Li), rubidium (Rb), cesium (Cs) and francium (Fr); and
(ii) 0.1-100 parts of weight of at least one fifth-period metal selected from the group consisting of rubidium (Ru), palladium (Pd), silver (Ag), zirconium (Zr), niobium (Nb) and indium (In).

5. The catalyst composition of claim 4, further comprising a diesel particulate filter (DPF).

6. The catalyst composition of claim 4, further comprising a diesel oxidation catalyst unit (DOC).

7. The catalyst composition of claim 5, wherein diesel particulate filter (DPF) comprises a diesel exhaust after-treatment system.

8. A catalyst composition for the reduction of nitrogen oxide, comprising:
(I) an inorganic refractory supporter consisting of a mixture of Al₂O₃ and BaTiO₃; and
(II) a catalyst comprising:
(i) at least one fifth-period metal selected from the group consisting of rubidium (Ru), palladium (Pd), silver (Ag), zirconium (Zr), niobium (Nb) and indium (In), wherein the fifth-period metal is contained in an amount of 0.1-100 parts by weight based on 1 part by weight of the group I metal.; and
(ii) at least one group I metal selected from the group consisting of lithium (Li), rubidium (Rb), cesium (Cs) and francium (Fr).

9. (canceled)

10. The catalyst composition of claim 8, wherein the inorganic refractory supporter is contained in an amount of 10-1.000 parts by weight based on 1 part by weight of the catalyst components (i) and (ii).

11. The catalyst composition of claim 8, wherein the BaTiO₃ component in the supporter is contained in an amount of 0.01-100 parts by weight based on 1 part by weight of the Al₂O₃ component.

12. The catalyst composition of claim 8, further comprising a nitrogen oxide removal unit (DeNOx).

13. The catalyst composition of claim 12, wherein the nitrogen oxide removal unit (DeNOx) comprises a diesel exhaust after-treatment system and a diesel particulate filter (DPF).

14. The diesel exhaust after-treatment system of claim 13, wherein a pressure sensor, a light oil (or dimethyl ether) injection nozzle and a heater for the injection nozzle are positioned in front of the nitrogen oxide removal unit (DeNOx) of claim 12, such that a predetermined amount of light oil (or dimethyl ether) is injected, if necessary to remove nitrogen oxide (NOx), depending on nitrogen oxide emission calculated based on the RPM and load of an engine, and wherein a pressure sensor is positioned in the rear of the diesel particulate filter (DPF) of claim 7, such that, if the pressure difference between the pressure sensor in the nitrogen oxide removal unit and the pressure sensor in the diesel particulate filter (DPF) is more than 200 mbar, the amount of light oil (or dimethyl ether) injected through the injection nozzle will be increased compared to the amount required as a reducing agent in the nitrogen oxide removal unit and oxidized in the ceramic filter of the diesel particulate filter to generate instantaneous heat so as to regenerate deposited particulate matter at low temperatures, and if the pressure difference is less than 150 mbar, light oil (or dimethyl ether) will be injected through the nozzle in the amount required in the nitrogen oxide removal unit (DeNOx).

15. The diesel exhaust after-treatment system of claim 13, which additionally comprises a diesel oxidation catalyst unit (DOC).

16. The diesel exhaust after-treatment system of claim 15, wherein a pressure sensor, a light oil (or dimethyl ether) injection nozzle and a heater for the injection nozzle are positioned in front of the nitrogen oxide removal unit (DeNOx), such that a predetermined amount of light oil (or dimethyl ether) is injected, if necessary, to remove nitrogen oxide (NOx), depending on nitrogen oxide emission calculated based on the RPM and load of an engine, and wherein a pressure sensor is positioned in the rear of the diesel particulate filter (DPF), such that, if the pressure difference between the pressure sensor of the nitrogen oxide removal unit and the pressure sensor of the diesel particulate filter (DPF) is more than 200 mbar, the amount of light oil (or dimethyl ether) injected through the injection nozzle will be increased compared to the amount required as a reducing agent in the nitrogen oxide removal unit and oxidized in the ceramic filter of the diesel particulate filter to generate instantaneous heat so as to regenerate deposited particulate material at low temperatures, and if the pressure difference is less than 150 mbar, light oil (or dimethyl ether) will be injected through the nozzle in the amount required in the nitrogen oxide removal unit (DeNOx), and wherein the diesel oxidation catalyst unit (DOC) serves to remove particulate matter of less than 1 μm, hydrocarbon and carbon monoxide, untreated in the diesel particulate filter (DPF).

17. The catalyst composition of claim 6, wherein the diesel oxidation catalyst unit (DOC) comprises a diesel exhaust after-treatment system.
